(19) United States
(12) Patent Application Publication
(10) Pub. No.: US 2012/0263479 A1
(43) Pub. Date: Oct. 18, 2012

(54) OPTICAL NETWORK COMMUNICATION SYSTEM WITH VARIABLE OPTICAL ATTENUATION AND METHOD OF OPERATION THEREOF

(75) Inventors: Guangpeng Ma, Shenzhen (CN); Nicolas Herriau, Shenzhen (CN)

(73) Assignee: NeoPhotonics Corporation, San Jose, CA (US)

(21) Appl. No.: 13/089,100

(22) Filed: Apr. 18, 2011

(51) Int. Cl. H04B 10/00

(52) U.S. Cl. 398/159

(57) ABSTRACT

A method of operation of an optical network communication system includes: coupling an input fiber; receiving light with a lens from the input fiber, the light having a predetermined amount of mode-field-diameter dispersion; tilting a mirror for reflecting the light after the light is transmitted through the lens; and positioning an output fiber for retransmitting the light from the lens after the light is reflected from the mirror for wavelength-dependent-loss reduction.

### TECHNICAL FIELD

The present invention relates generally to an optical network communication system, and more particularly to a system for a system with variable optical attenuation.

### BACKGROUND ART

Fiber optics refers to the technical art of transmitting light from place to place over a thin strand of glass known as an optical fiber. Optical fibers can carry light over great distances with little loss. Optical fibers are also flexible and allow light to be directed along cables, around corners, for example, without the use of mirrors.

Variable optical attenuators (VOA) are typically used in conjunction with optical amplifiers. Passive optical networks (PON) are passive networks that do not use optical amplifiers, and so generally VOAs are not used in PONs. VOAs are used in long-haul networks that transport highly aggregated data from many users on densely-packed wavelengths between distant cities and urban areas, which are generally hundreds or even thousands of miles apart. VOAs are also becoming more common in metropolitan-area networks transporting moderately-aggregated data also on densely-packed wavelengths between and among Central Offices.

From the Central Offices, the data is segregated according to the intended user and sent out to those users on PONs and other access networks that are optical and/or electrical. Optical access networks, such as PONs, generally have only a few wavelengths. At any instant in time, each branch only has a connection for one or two users with the Central Office. The network rapidly scans the instantaneous user among all the connected users to provide apparently seamless data service (hopefully) to all the users. In the future, there may be more wavelengths in access networks, but less likely optical amplifiers, so they are less likely candidates for VOA applications.

A most important application of fiber optics is in telecommunications where voice signals, private data, and internet data may be carried by light traveling through optical fibers. An optical fiber is capable of carrying much more information over significant distances than a copper wire. The rise of the internet especially has driven demand for more communications capacity and more fiber optic systems.

Fiber optic systems include many types of components to perform functions such as converting data into light signals, amplifying or attenuating light signals, and combining several signals on one fiber. Optical attenuators are devices that are used to reduce the power of light in a fiber so it may be maintained at an optimal level for high-fidelity transmission. The amount of attenuation in a variable optical attenuator is easily adjustable, for example by electronic control.

Optical attenuators are used for power management, equalization among different wavelength channels, gain control in amplifiers, overload protection and other tasks. It is convenient to include variable optical attenuators in a fiber optic system in order to easily adjust light power in various parts of the system.

Thus, a need still remains for an optical network communication system with variable optical attenuation mechanism for increasing levels of functionality. In view of substantial demand for further improved performance, it is increasingly critical that answers be found to these problems. In view of the ever-increasing commercial competitive pressures, along with growing consumer expectations and the diminishing opportunities for meaningful product differentiation in the marketplace, it is critical that answers be found for these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

The present invention provides a method of operation of an optical network communication system including: coupling an input fiber; receiving light with a lens from the input fiber, the light having a predetermined amount of mode-field-diameter dispersion; tilting a mirror for reflecting the light after the light is transmitted through the lens; and positioning an output fiber for retransmitting the light from the lens after the light is reflected from the mirror for wavelength-dependent-loss reduction.

The present invention provides an optical network communication system, including: an input fiber; a lens, coupled to the input fiber, for receiving light from the input fiber; a mirror, coupled to the lens, for reflecting the light after the light is transmitted through the lens; an output fiber, coupled to the lens, for receiving the light transmitted with a predetermined amount of mode-field-diameter dispersion after the light is reflected from the mirror and retransmitted through the lens for wavelength-dependent-loss reduction.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a schematic side view of an optical network communication system with variable optical attenuation mechanism in an embodiment of the present invention.

FIG. 2 is a schematic top view of the optical network communication system.

FIG. 3 is an exemplary graph of mode size versus wavelength.

FIG. 4 is a diagram of fibers with low mode-field-diameter dispersion.

FIG. 5 is a diagram of the mirror.

FIG. 6 is a detailed view of the mirror.

FIG. 7 is an example of a graph of attenuation versus voltage.

FIG. 8 is a plan view of an exemplary arrangement of the mirror in an alternative embodiment.

FIG. 9 is a cross-sectional side view of the mirror in a rotational position in the alternative embodiment.

FIG. 10 is a graph of wavelength-dependent-loss versus attenuation.

FIG. 11 is a flow chart of a method of operation of the optical network communication system in a further embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

The drawings showing embodiments of the system are semi-diagrammatic and not to scale and, particularly, some of the dimensions are for the clarity of presentation and are shown exaggerated in the drawing FIGs. Similarly, although the views in the drawings for ease of description generally show similar orientations, this depiction in the FIGs. is arbitrary for the most part. Generally, the invention can be operated in any orientation. The embodiments have been numbered first embodiment, second embodiment, etc. as a matter of descriptive convenience and are not intended to have any other significance or provide limitations for the present invention.

The term “module” referred to herein can include software, hardware, or a combination thereof For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof.

The mode-field-diameter dispersion can be partially compensated. As a result, the wavelength dependence loss can be only partially improved. Also, it can introduce the need for using special glass material with high index dispersion (Δn/Δλ), adding to the component cost and limiting design options. Issues of wavelength-dependent-loss in a tilting-mirror variable optical attenuator (VOA) can be solved by reducing the problems with specialty lens. These VOAs use industry-standard fibers for all basic applications, such as being buried underground between phone offices.

It would be desirable to have a tilting mirror MEMS VOA with as small wavelength-dependent-loss (WDL) as possible over a wide range of operating wavelengths and attenuation levels. Embodiments of the present invention provide answers or solutions to the problem.

The WDL of a tilting mirror VOA is extremely sensitive to the precise mode-field-diameter (MFD) dispersion of the fiber. Mode-field-diameter dispersion at this level is not a designable property of an optical fiber and is not characterized or specified by fiber manufacturers. Mode-field-diameter dispersion is an empirical consequence of physical structures of an optical fiber that are designed to comply with more basic requirements for the fiber as an optical-transport medium and without regard to or characterization or consideration of the detailed MFD dispersion. An ideal MFD dispersion can be predominantly less than an MFD dispersion of fibers that interface to optical networks. However, an MFD dispersion of essentially zero would not provide minimal wavelength-dependent-loss (WDL) in a practical VOA.

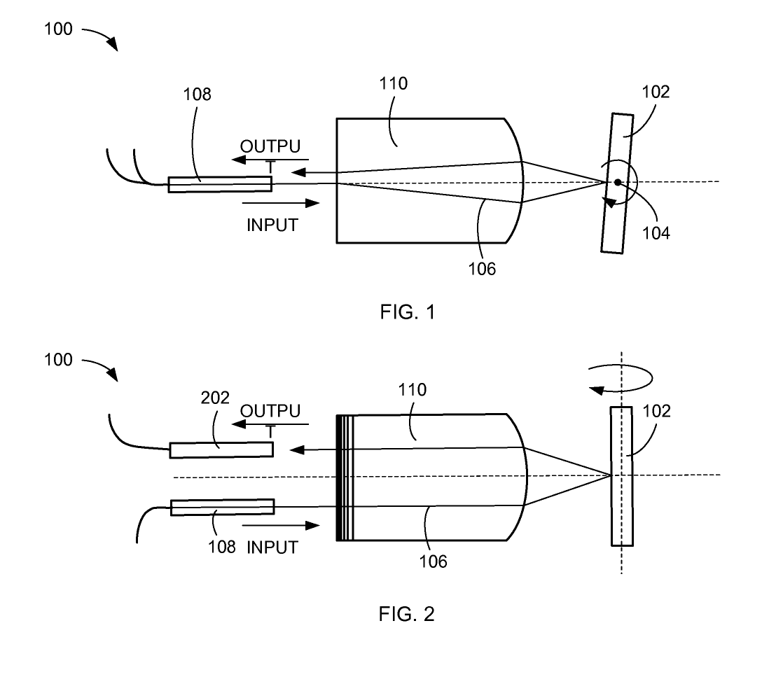

Referring now to FIG. 1, therein is shown a schematic side view of an optical network communication system 100 with variable optical attenuation mechanism in an embodiment of the present invention. The side view is schematically shown with the optical network communication system 100 having a tilting mirror microelectromechanical systems (MEMS) variable optical attenuator (VOA) in an attenuation state.

The optical network communication system 100 can include a mirror 102 to transfer or reflect light beam between fibers. The mirror 102 can be tilted in an attenuation state. The attenuation state is a condition in which transmission loss or reduction in intensity of a light beam or signal occurs in a fiber cable. The mirror 102 can be tilted or rotated about a rotation axis 104.

The side view depicts a light 106 propagates or is directed from an input fiber 108 coupled toward and through a lens 110. The light 106 can be reflected by the mirror 102, re-enter or retransmit through the lens 110, and propagate toward another fiber in an output direction.

The input fiber 108 is a fiber cable that is fitted before it is attached to a network equipment (not shown). The input fiber 108 can be fitted with a fiber pigtail or have a connector attached.

The light 106 can be slightly offset when the light 106 is transmitted from the lens 110 and approaches the fiber in the output direction. The offset is a consequence of a rotation of the mirror 102 and can account for the attenuation of the reflected signal by controlling the amount of overlap with the receiving optical cable. Light beam traveling along an offset path does not couple into a fiber as efficiently as light beam traveling along a path coinciding with an axis of the fiber.

Referring now to FIG. 2, therein is shown a schematic top view of the optical network communication system 100. The optical network communication system 100 can include an output fiber 202. The output fiber 202 is a fiber cable that is fitted before it is attached to the network equipment (not shown). The output fiber 202 can be positioned or fitted with a fiber pigtail or have a connector attached.

Fiber cable fitting means preparing a distal end of a fiber for connection to a fiber-optic network. This fitting is not essential to the function of the VOA, but is essential to enable using the VOA in its intended application. This fitting can be, for instance, leaving an extended length of fiber bare, attaching a suitable fiber-optic connector directly to the distal end, or fusion-splicing a separately-fitted segment of fiber to the distal end.

The light 106 can be slightly offset when the light 106 is transmitted from the lens 110 and received by the output fiber 202. The light 106 can be transmitted from the output fiber 202 in the output direction. The term “offset” refers to the light 106 transmitted along a path that is at an angle from an axis of the output fiber 202. In other words, the path is not along or not coinciding with the axis of the output fiber 202.

The input fiber 108 and the output fiber 202 can be coupled to the lens 110. The lens 110 can be coupled to the mirror 102. The light 106 can be transmitted with a predetermined amount of mode-field-diameter dispersion after the light 106 is retransmitted through the lens 110 into the output fiber 202 such that when the mirror 102 is tilted and coupled to the output fiber 202 at an offset to reduce the coupling of light between the input fiber 108 and the output fiber 202 to a predetermined coupling fraction.

The predetermined amount of mode-field-diameter dispersion can be provided by selecting at least one of the input fiber 108 and the output fiber 202 to be a type of fibers that withstands tighter bends including a reduced-bend-radius fiber, as an example. The reduced-bend-radius fiber withstands bends tightly with no discernable increase in attenuation within frames, panels, or pathways. That is, the reduced-bend-radius fiber is less susceptible to macro bends that affect attenuation and limit bandwidth of optical fiber links.

For example, the reduced-bend-radius fiber can represent a depressed-clad fiber or a fiber having a cladding profile that rings the core with a lower index of refraction than that of the fiber's extended cladding, causing light to stay more tightly confined within the fiber's core.

When an optical fiber is bent, it suffers two primary impairments: some of the optical signal contained in the core radiates out at the bend and contributes additional loss; and mechanical stress on the glass fiber can adversely affect reliability. Single-mode optical fibers for fiber-optic networks specify a minimum (e.g. tightest) bending radius approved. For such fibers, bending radius typically falls in a range from 30 millimeters (mm) to 40 millimeters (mm) and can be limited by optical performance. The tighter confinement of the reduced-bend-radius fiber can allow a reduction of the bending radius such that the bending radius typically falls in the range of 5 millimeters (mm) to 15 millimeters (mm), and can be limited by mechanical stress on the glass fiber rather than optical performance. Examples of types of reduced-bend-radius fiber from suppliers can include any type of fibers that withstands tighter bends including Corning “Clear Curve”™, Sumitomo “Pure Access”™, OFS AllWave® “FLEX Fiber”™, Sterlite “BEND-LIGHT”™, and Draka “Bend Bright”™.

As an example, the reduced-bend-radius fiber can include a bending radius reduction of approximately 2 times to 10 times or more compared to standard fibers. In other words, the reduced-bend-radius fiber can include a bending radius approximately 50% to 10% or less compared to bending radii of standard fibers.

It has been discovered that the predetermined amount of mode-field-diameter dispersion substantially reduces or effectively eliminates the sensitivity to optical wavelength of the predetermined coupling fraction and provides a reduction to wavelength-dependent loss in the output fiber 202.

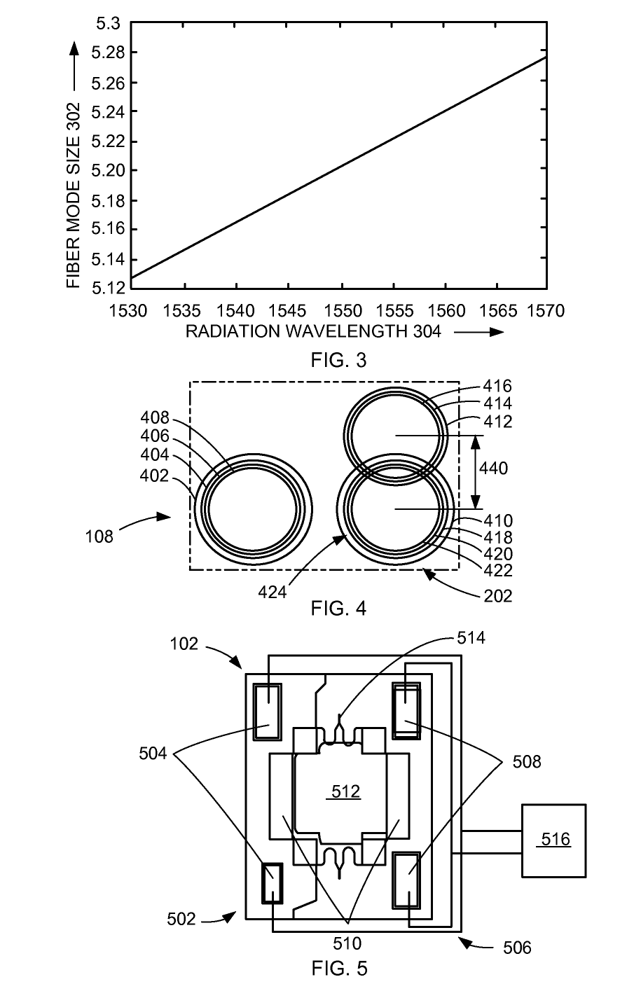

Referring now to FIG. 3, therein is shown an exemplary graph of mode size versus wavelength. In the graph, a fiber mode size 302 of an optical fiber, such as the input fiber 108 of FIG. 1 or the output fiber 202 of FIG. 2, is plotted versus a radiation wavelength 304 of the light 106 of FIG. 1 traveling in the optical fiber. The fiber mode size 302 is a mode-field-diameter (MFD) or a size of an optical mode in a fiber for a wavelength. The radiation wavelength 304 is a distance between two wave crests of light beam or an electromagnetic radiation. The graph depicts the radius of the fiber mode size 302 in microns (um) and the radiation wavelength 304 in nanometers (nm).

For example, over a range of the radiation wavelength 304 from 1530 nanometers (nm) to 1570 nanometers (nm), the radius of the fiber mode size 302 can vary from approximately 5.125 microns (um) to approximately 5.275 microns (um). This variation of the fiber mode size 302 with the radiation wavelength 304 can lead to a variation of the fractional overlap of the output spot on the output fiber 202 at a fixed offset. Hence, this variation can lead to wavelength-dependent-loss (WDL) in a tilting mirror microelectromechanical system (MEMS) variable optical attenuator (VOA).

Referring now to FIG. 4, therein is shown a diagram of fibers with low mode-field-diameter dispersion. The diagram depicts the fibers, such as the input fiber 108 and the output fiber 202. The diagram depicts schematically optical spot and fiber mode sizes for various wavelengths in a tilting mirror microelectromechanical system (MEMS) variable optical attenuator (VOA) in an attenuation state.

Mode-field-diameter (MFD) is a measure of a spot size or a beam width of the light 106 of FIG. 1 propagating in a fiber. MFD is an expression of distribution of irradiance, or an optical power per unit area, across an end face of a fiber. MFD defines the lateral size of the power distribution of the light 106 propagating through a fiber. MFD can be determined based on source wavelength, fiber core radius, fiber refractive index profile, or a combination thereof

Mode-field-diameter (MFD) dispersion is defined as a difference measured between an MFD of a wavelength and another MFD of another wavelength of the light 106 being transmitted. Low mode-field-diameter (MFD) dispersion is defined as a difference between an MFD of the shortest wavelength and an MFD of the longest wavelength of the light 106 being transmitted, all divided by the difference between the longest and shortest wavelengths. An MFD dispersion can be unit-less or can be expressed in units of, for example, microns/nanometer. For example, a mode-field-diameter (MFD) can be 8.6 microns (um) or 9.65 microns (um) for wavelength of 1310 nanometers (nm) or 1550 nanometers (nm), respectively.

In general, a mode diameter refers to a diameter where an optical power is 1/e² of its maximum value, but any other consistent definition of a mode diameter may be adopted. For clarity, “e” is the number the natural logarithm of which is unity, an irrational constant approximately equal to 2.718281828.

Wavelength-dependent-loss (WDL) of a variable optical attenuator (VOA) can be determined, estimated, or inferred based on mode-field-diameter (MFD) variation, mode-field-diameter (MFD) dispersion, or a combination thereof. For example, wavelength-dependent-loss (WDL) can be larger or smaller due to a larger or smaller mode-field-diameter (MFD) variation. A variable optical attenuator (VOA) with nearly or approximately zero wavelength-dependent-loss (WDL) does not indicate that mode-field-diameter (MFD) variation is nearly or approximately zero.

Mode-field-diameter (MFD) numbers can be determined from wavelength-dependent-loss (WDL) characteristics. Mode-field-diameter (MFD) variation can be determined, estimated, or inferred based on a measurable quantity or relationship of attenuation versus offset.

A tilting mirror microelectromechanical system (MEMS) variable optical attenuator (VOA) can attenuate the light 106 over a broad band of wavelengths with minimum wavelength-dependent-loss (WDL). Wavelength-dependent-loss (WDL) can be generated by the fiber dispersion of its mode-field-diameter (MFD) over wavelength. As a light beam is steered away from a receiving fiber core for creating attenuation, the coupling ratio can depend on the size of the light beam, which is a function of the wavelength. One way to limit VOA attenuation wavelength dependence is to use fibers with lower MFD dispersion.

A core input mode 402 represents a core of an optical fiber, such as the input fiber 108. A first input mode 404, a second input mode 406, and a third input mode 408 represent mode diameters or sizes of optical modes in the input fiber 108 for different wavelengths. The first input mode 404, the second input mode 406, and the third input mode 408 can be smaller than the core input mode 402. For example, the first input mode 404, the second input mode 406, and the third input mode 408 can represent fiber mode sizes of optical beams of different wavelengths.

A core output mode 410 represents a core of an optical fiber, such as the output fiber 202. A first output mode 412, a second output mode 414, and a third output mode 416 represent mode diameters or sizes of optical modes of the light 106 in the output fiber 202 for different wavelengths.

The first output mode 412, the second output mode 414, and the third output mode 416 can be smaller than the core output mode 410. For example, the first output mode 412, the second output mode 414, and the third output mode 416 can represent spot sizes and positions of optical beams of different wavelengths arriving at the output fiber 202.

The fiber modes for wavelengths corresponding to the first output mode 412, the second output mode 414, and the third output mode 416 are represented by a first fiber mode 418, a second fiber mode 420, and a third fiber mode 422, respectively. The first fiber mode 418, the second fiber mode 420, and the third fiber mode 422 can be smaller than the core output mode 410.

In a low-loss state of a tilting mirror MEMS VOA, a spot size of free propagating light can match a fiber mode size of output fibers. Furthermore, optical spots can be centered on and overlap fiber modes. In the low-loss state, the light can exactly overlay the fiber mode field of the receiving optical cable. For example, the first output mode 412, the second output mode 414, and the third output mode 416 can be completely aligned with the first fiber mode 418, the second fiber mode 420, and the third fiber mode 422, respectively.

In the attenuation state, the first output mode 412, the second output mode 414, and the third output mode 416 can include sizes that match sizes of corresponding modes of the output fiber 202. However, the first output mode 412, the second output mode 414, and the third output mode 416 can be non-aligned with positions of fiber modes of the output fiber 202.

Spots and their corresponding modes can be offset by a reflective offset 440, as shown with a label “δx”, which is a length between a center of the spots and a center of their corresponding modes. The reflective offset 440 is shown to indicate that the spots are away from their corresponding modes due to attenuation. The spots include the first output mode 412, the second output mode 414, and the third output mode 416. The corresponding modes include the first fiber mode 418, the second fiber mode 420, and the third fiber mode 422.

The first output mode 412, the second output mode 414, and the third output mode 416 and the first fiber mode 418, the second fiber mode 420, and the third fiber mode 422, respectively, can partially overlap. Attenuation at a wavelength corresponding to the third output mode 416 can be greater than that at a wavelength corresponding to the second output mode 414. Attenuation at a wavelength corresponding to the second output mode 414 can be greater than that at a wavelength corresponding to the first output mode 412.

Attenuation at a specific offset k can thus vary with wavelength; this is the primary source of wavelength-dependent-loss (WDL). A wavelength corresponding to the third output mode 416 can be shorter than a wavelength corresponding to the second output mode 414. A wavelength corresponding to the second output mode 414 can be shorter than a wavelength corresponding to the first output mode 412.

Wavelength-dependent-loss (WDL) is a measure of the difference in attenuation at different wavelengths for a fixed setting of an optical attenuator. As an example, consider an optical attenuator that works at wavelengths in the range between 1.53 micrometers (um) and 1.57 micrometers (um) and is operating at an intended or predetermined attenuation of 10 decibels (dB). If the actual attenuation is 9.75 decibels (dB) at 1.53 micrometers (um) and increases to 10.25 decibels (dB) at 1.57 micrometers (um), then the WDL over the range 1.53 micrometers (um) to 1.57 micrometers (um) is 0.5 decibel (dB) (10.25−9.75=0.5) when the average attenuation is 10 decibels (dB).

Attenuation can be determined by controlling the amount of overlap of the reflected signal with the receiving optical cable, such as the output fiber 202. The attenuation can be determined based on the overlap between the first output mode 412, the second output mode 414, and the third output mode 416 and the first fiber mode 418, the second fiber mode 420, and the third fiber mode 422, respectively. Wavelength-dependent-loss can include a measure of the difference between an attenuation corresponding to the first output mode 412 and the first fiber mode 418 and an attenuation corresponding to the third output mode 416 and the third fiber mode 422.

When a light beam is partially steered away from a receiving fiber, such as the output fiber 202, a coupling ratio can depend on a size of the light beam and the size of the receiving mode. The fibers can include less dispersion of their mode-field-diameter (MFD) over wavelength. The MFD is smaller for shorter wavelength and bigger for longer wavelength.

At a given offset distance δx, depicted as the reflective offset 440, a coupling ratio into the receiving fiber can be less at a shorter wavelength, such as a wavelength corresponding to the third output mode 416, than at a longer wavelength, such as a wavelength corresponding to the first output mode 412. The coupling ratio into the receiving fiber can vary less with wavelength.

The first output mode 412, the second output mode 414, and the third output mode 416 represent concentric circles with the same center among each other. The first fiber mode 418, the second fiber mode 420, and the third fiber mode 422 represent concentric circles with the same center among each other.

The light 106 can include a predetermined amount 424 of mode-field-diameter dispersion. The predetermined amount 424 is a value determined to reduce the wavelength-dependent-loss in the output fiber 202 of FIG. 2 to a pre-calculated range to meet specific quality and reliability transmission requirements. The predetermined amount 424 refers to the mode-field-diameter dispersion of the light 106 transmitted in the output fiber 202.

It has been discovered that the input fiber 108 and the output fiber 202 having predetermined low mode-field-diameter (MFD) dispersion with wavelengths significantly reduce wavelength-dependent-loss (WDL) in variable optical attenuator (VOA).

It has been unexpectedly found that wavelength-dependent-loss (WDL) is minimized or reduced when mode-field-diameter (MFD) dispersion of a fiber, depicted as the input fiber 108 or the output fiber 202, optimally offsets unavoidable wavelength dispersion of other optical elements in a variable optical attenuator (VOA) structure.

It has been unexpectedly determined that wavelength-dependent-loss (WDL) is reduced in variable optical attenuators (VOA) of different configurations including with or without introduction of a dispersive element or a specialty lens providing greater design flexibility for meeting other performance requirements of the VOAs, thereby more effectively solves the root cause of WDL rather than merely compensating for it.

The tilting mirror technology for constructing a variable optical attenuator (VOA) of the present invention can be selected from numerous technology options for one-dimensional (1D) microelectromechanical system (MEMS) or sub-miniature variable-position mirrors. The angular position of such mirrors can be set to specific positions within a continuous range by applying an actuation force typically derived from an applied voltage level. The fundamental physical basis of the actuation force can include one or more of electrostatic, electromagnetic, thermal, or piezoelectric.

The support of the primary VOA function can be essentially addressed equally by many of mirror technology choices. A preferred choice for a particular application can include a combination of secondary and less direct considerations. The tilting mirror embodiments subsequently described in FIGS. 5-9 are exemplary and can be preferred for certain applications. The descriptions of these figures also provide a basic framework that can be followed to apply other equivalent tilting-mirror technologies in cases where they may be preferred.

Referring now to FIG. 5, therein is shown a diagram of the mirror 102. The mirror 102 can include a first capacitive plate 502 having first contact pads 504. The mirror 102 can include a second capacitive plate 506 having second contact pads 508.

Electric voltage differential can be applied to the first contact pads 504 and the second contact pads 508. A variable applied voltage can be used to generate variable electrostatic forces among electrode fingers 510 of the first capacitive plate 502 and the second capacitive plate 506. The electrostatic forces apply a torque that rotates a reflective element 512 at a rotation axis at a hinge 514.

The first contact pads 504 and the second contact pads 508 can be connected to a power supply 516, which is a power source that supplies electrical energy to one or more electric loads. The power supply 516 can apply or provide the voltage to the first contact pads 504 and the second contact pads 508. The power supply 516 can thus be coupled to drive the rotation of the mirror 102.

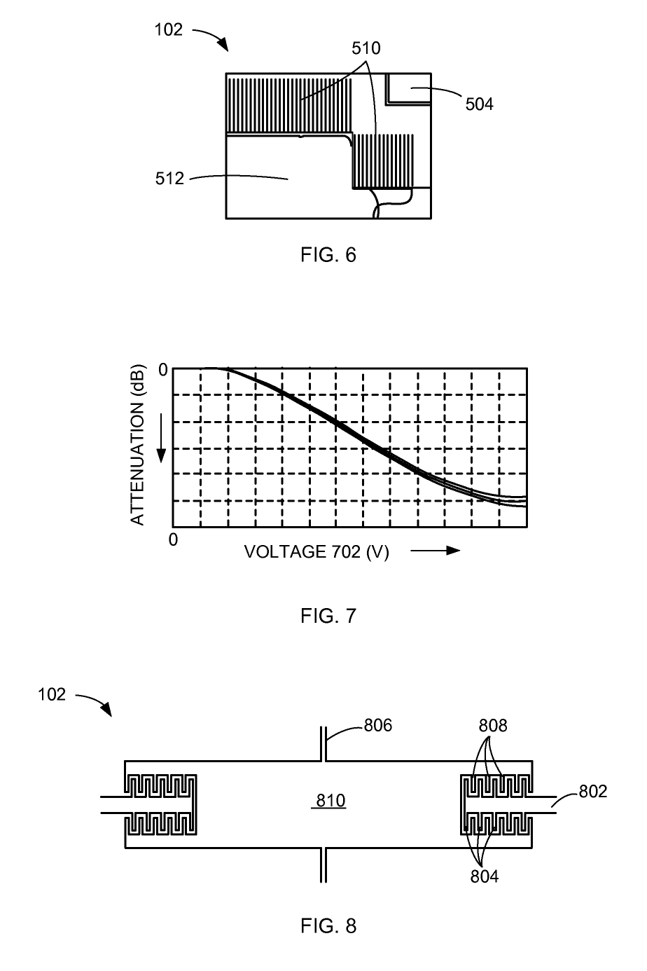

Referring now to FIG. 6, therein is shown a detailed view of the mirror 102. The detailed view depicts one of the first contact pads 504 adjacent the electrode fingers 510. The first contact pads 504 can be driven by the power supply 516 of FIG. 5 with sufficient voltage to produce electrical fields in the electrode fingers 510 to rotate the reflective element 512.

Referring now to FIG. 7, therein is shown an example of a graph of attenuation versus voltage. The graph depicts attenuation increases from top to bottom in the vertical (or Y) axis and a voltage 702 increases from left to right in the horizontal (or X) axis. The graph can be applicable to a bright configuration in which the attenuation is minimum with no voltage applied to the mirror 102 of FIG. 1. The voltage 702 can be supplied by the power supply 516 of FIG. 5.

The attenuation can increase as the voltage 702 increases. The relative attenuation can slowly increase from zero decibel (dB) as the voltage 702 increases from zero volt (V). The attenuation can increase as the voltage 702 increases. The attenuation can slowly increase with a rate of change of attenuation-over-voltage approaching zero when the voltage 702 reaches at least a predetermined voltage level.

The attenuation vs. voltage relationship can be nonlinear, but can be monotonic and predictable. The relationship can be characterized in the driving electronics such that specific attenuations can be selected by applying specific voltages without need to interactively monitor the actual attenuation. This is a mode of operation that is critical in many applications of the VOA and illustrates why low wavelength-dependent loss (WDL) is a crucial performance requirement for VOAs. A particular level of attenuation must be achieved at a particular voltage setting regardless of the wavelength of any and all optical signals in the connected fibers.

The voltage 702 can be supplied to the first contact pads 504 of FIG. 5 and the second contact pads 508 of FIG. 5 to create the electric fields, causing a torque that rotates the reflective element 512 of FIG. 5 about a torsional hinge, depicted as the hinge 514 of FIG. 5. Thus, the mirror 102 of FIG. 1 can be rotated to reflect the light 106 of FIG. 1 thereby generating the attenuation of the light 106. Therefore, the voltage 702 can determine the amount of attenuation of the light 106 at the output fiber 202 of FIG. 2.

The bright configuration referred to above is a configuration of a variable optical attenuator (VOA) that is normally bright. In the bright configuration and when the mirror is in a resting position, light is well aligned between input and output fibers, there is little loss, and the output fiber is ‘bright’ (assuming light is at the input). The resting position means that the voltage 702 is not applied to the mirror 102. As the voltage 702 is applied, the light is driven out of alignment, and the output fiber becomes dark.

For illustrative purposes, the variable optical attenuator (VOA) is described with the bright configuration, although it is understood that the variable optical attenuator can be made with any default configuration, depending on where a user wants the default optical loss to be in a case of a power break. For example, the variable optical attenuator can be made with a default configuration of normally dark. In a normally dark VOA, a resting position of the mirror 102 is out of alignment and applying a voltage drives the mirror 102 into alignment.

Referring now to FIG. 8, therein is shown a plan view of an exemplary arrangement of the mirror 102 in an alternative embodiment. The plan view illustrates a design of the mirror 102 using an antenna shaped comb drive, which allows improved efficiency of the electromagnetic rotation of the mirror 102 though at the expense of increased footprint. The alternative arrangement can be preferred for some applications, particularly where reduced drive voltages would be required.

The plan view depicts an exemplary arrangement of a steering element, such as the mirror 102, in accordance with one aspect of the present invention. The mirror 102 can include a stator comb 802, which is comb-like structure arranged as a plurality of stator electrode comb fingers 804. The stator comb 802 is a portion of a mechanical device that is stationary around which a rotor can revolve.

The stator electrode comb fingers 804 are organized in an “antenna” geometry such that the stator electrode comb fingers 804 lie substantially parallel to a rotation hinge 806. The rotation hinge 806 represents the hinge 514 of FIG. 5.

The stator electrode comb fingers 804 can be interdigitated or interlocked with a plurality of rotor electrode comb fingers 808, which are formed integrally with a reflective element 810. Torsional hinges, such as a plurality of the rotation hinge 806, can be attached substantially at a centerline of the reflective element 810. The rotor electrode comb fingers 808 and the stator electrode comb fingers 804 can be situated substantially parallel to the rotation hinge 806 and to an axis of rotation of the reflective element 810, about which the rotor electrode comb fingers 808 rotate relative to the stator electrode comb fingers 804.

The stator comb 802 can be driven with a voltage to produce electric fields in a region of interdigitated antenna fingers, such as the stator electrode comb fingers 804 interdigitated with the rotor electrode comb fingers 808. The interdigitated antenna fingers can be folded substantially parallel to an axis of rotation. The voltage 702 of FIG. 7 can be supplied to the first contact pads 504 of FIG. 5 and the second contact pads 508 of FIG. 5 to create the electric fields, causing a torque that rotates the reflective element 512 of FIG. 5 and the rotor electrode comb fingers 808.

The stator electrode comb fingers 804 can be arranged in an antenna shape, and the rotor electrode comb fingers 808 can surround the stator electrode comb fingers 804. The rotor electrode comb fingers 808 can be rotated relative to the stator electrode comb fingers 804 to reflect the light 106 of FIG. 1 from the lens 110 of FIG. 1. The stator electrode comb fingers 804 and the rotor electrode comb fingers 808 represent the electrode fingers 510 of FIG. 5.

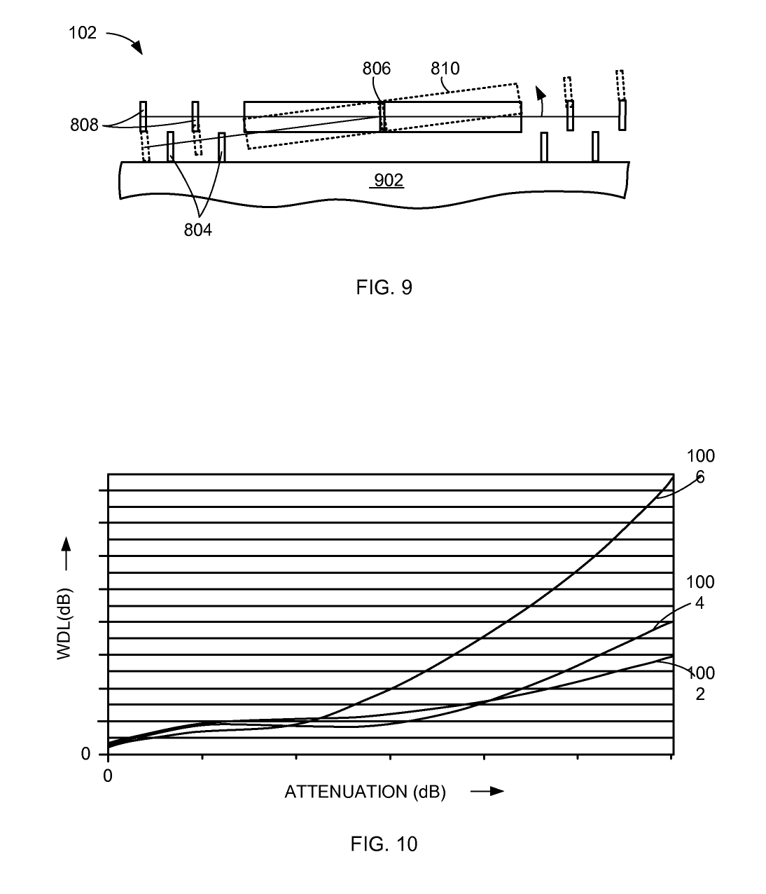

Referring now to FIG. 9, therein is shown a cross-sectional side view of the mirror 102 in a rotational position in the alternative embodiment. The cross-sectional side view depicts a change in gap between the rotor electrode comb fingers 808 and the stator electrode comb fingers 804 during rotation. The cross-sectional side view also depicts the reflective element 810 and the rotation hinge 806.

At least certain arrangements of the present invention minimize a problem of mechanical interference between the interdigitated rotor and stator electrodes, such as the rotor electrode comb fingers 808 and the stator electrode comb fingers 804, at least for small angles of rotation characteristic of such devices. More specifically, the reflective element 810 can be limited in its range of motion a physical stop, such as a substrate 902, before any portion of the rotor electrode comb fingers 808 can contact the stator electrode comb fingers 804, while still permitting actuation of up to several degrees of tilt.

Referring now to FIG. 10, therein is shown a graph of wavelength-dependent-loss versus attenuation. The graph depicts the wavelength-dependent-loss (WDL) comparison per fiber type. The graph depicts a first wavelength-dependent-loss 1002, a second wavelength-dependent-loss 1004, and a third wavelength-dependent-loss 1006, which are differences in attenuation at different wavelengths per fiber type.

The first wavelength-dependent-loss 1002 represents a wavelength-dependent-loss (WDL) of the present invention with a fiber type having the predetermined MFD dispersion. The second wavelength-dependent-loss 1004 and the third wavelength-dependent-loss 1006 represent wavelength-dependent-losses with fiber types having higher MFD dispersions than that of the fiber type with the first wavelength-dependent-loss 1002.

The first wavelength-dependent-loss 1002 does not change or increase as much as the second wavelength-dependent-loss 1004 and the third wavelength-dependent-loss 1006 do as attenuation increases. For example, the first wavelength-dependent-loss 1002 can include an approximate range from 0.05 decibels (dB) to 0.60 decibels (dB) with an attenuation having an approximate range from 0 decibel (dB) to 30 decibels (dB).

Also for example, the second wavelength-dependent-loss 1004 can include an approximate range from 0.05 decibels (dB) to 0.80 decibels (dB) with an attenuation having an approximate range from 0 decibel (dB) to 30 decibels (dB). Further for example, the third wavelength-dependent-loss 1006 can include an approximate range from 0.05 decibels (dB) to 1.65 decibels (dB) with an attenuation having an approximate range from 0 decibel (dB) to 30 decibels (dB).

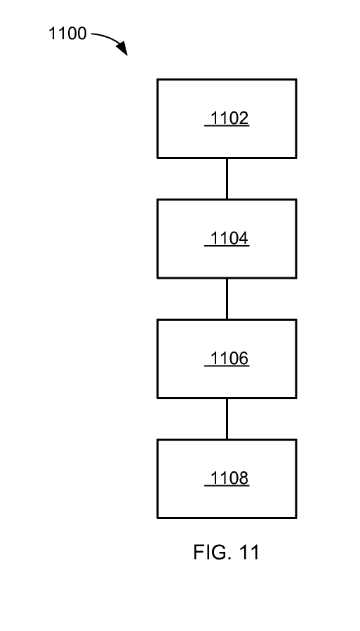

Referring now to FIG. 11, therein is shown a flow chart of a method 1100 of operation of the optical network communication system 100 in a further embodiment of the present invention. The method 1100 includes: coupling an input fiber in a block 1102; receiving light with a lens from the input fiber, the light having a predetermined amount of mode-field-diameter dispersion in a block 1104; tilting a mirror for reflecting the light after the light is transmitted through the lens in a block 1106; and positioning an output fiber for retransmitting the light from the lens after the light is reflected from the mirror for wavelength-dependent-loss reduction in a block 1108.

The present invention allows to almost completely eliminating WDL instead of only partially compensating for it, even with an introduction of a specialty dispersive element. The present invention solves the root cause of WDL rather than compensates for it. The use of specific fibers with low MFD dispersion over wavelength eliminates the root cause for WDL.

Types of fiber for interfacing to optical networks have a depressed index region ringing the core inside the normal cladding, i.e. with plot showing material index-of-refraction from the center of the core radially outward. These types of fiber of interest have an index-of-refraction starts ‘high’, then at the edge of the core drops to ‘lower than low’ for a short distance, perhaps a couple of microns, then comes back up to ‘low’ and continues out at that level beyond the extent of the optical region. This provides for much less performance degradation when the fiber is kinked such as might happen by stapling to the frame, but still allows acceptably efficient interfacing to the standard fiber connecting the building to the network. Such fiber does not need as heavy, bulky, costly jacketing as standard fiber installed in a building.

It is a technical finding that this index profile also changes the wavelength dependence of light coupled into the fiber from an offset axis in a way that is substantially beneficial to a VOA as described in this invention. In essence, a VOA can be designed to this fiber, and a substantially improved wavelength dependence of the device is achieved. The additional performance margin also makes assembly of the device easier, the cost of materials going into the device less expensive, and reliability is expected to improve. For example, fibers, such as photonic-crystal/‘holey’ fiber, likely can also offer improved, perhaps even better, wavelength characteristics for offset attenuation control, though the depressed-cladding fiber can be adequate and much more mature.

Measuring MFD accurately enough to distinguish these subtleties can be challenging, and in fact one of the more sensitive methods is to map wavelength vs. attenuation space using a highly-engineered device such as our attenuator. This only scans in one direction, so it is an inferred measurement in that it assumes circular symmetry of the mode.

Thus, it has been discovered that the optical network communication system of the present invention furnishes important and heretofore unknown and unavailable solutions, capabilities, and functional aspects for an optical network communication system with variable optical attenuation. The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization.

Another important aspect of the present invention is that it valuably supports and services the historical trend of reducing costs, simplifying systems, and increasing performance.

These and other valuable aspects of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of operation of an optical network communication system comprising:
coupling an input fiber;
receiving light with a lens from the input fiber, the light having a predetermined amount of mode-field-diameter dispersion;
tilting a mirror for reflecting the light after the light is transmitted through the lens; and
positioning an output fiber for retransmitting the light from the lens after the light is reflected from the mirror for wavelength-dependent-loss reduction.

2. The method as claimed in claim 1 wherein receiving the light includes receiving the light having a first output mode with a size matched a size of a first fiber mode, the first output mode corresponding to the light from the lens.

3. The method as claimed in claim 1 wherein receiving the light includes receiving the light having a first output mode concentric with a second output mode, the first output mode corresponding to the light from the lens.

4. The method as claimed in claim 1 wherein tilting the mirror includes rotating the mirror with a voltage supplied.

5. The method as claimed in claim 1 wherein tilting the mirror includes tilting the mirror having a reflective element integral with rotor electrode comb fingers, the light from the lens reflected with the rotor electrode comb fingers rotated.

6. A method of operation of an optical network communication system comprising:
coupling an input fiber;
receiving light with a lens from the input fiber, the light having a predetermined amount of mode-field-diameter dispersion;
tilting a mirror by a reflective offset for reflecting the light after the light is transmitted through the lens; and
positioning an output fiber for retransmitting the light from the lens after the light is reflected from the mirror for wavelength-dependent-loss reduction, the light partially offset from the output fiber for providing optical attenuation.

7. The method as claimed in claim 6 wherein receiving the light includes receiving the light having a first output mode with a size matched a size of a first fiber mode, the first output mode corresponding to the light from the lens and partially overlapped with the first fiber mode.

8. The method as claimed in claim 6 wherein receiving the light includes receiving the light having a first output mode and a second output mode that are concentric, a wavelength corresponding to the first output mode longer than a wavelength corresponding to the second output mode with the first output mode corresponding to the light from the lens.

9. The method as claimed in claim 6 wherein tilting the mirror includes rotating the mirror having rotor electrode comb fingers with a voltage supplied.

10. The method as claimed in claim 6 wherein tilting the mirror includes tilting the mirror having a rotation hinge and a reflective element integral with rotor electrode comb fingers, the light from the lens reflected with the rotor electrode comb fingers rotated and parallel to the rotation hinge.

11. An optical network communication system comprising:
an input fiber;
a lens, coupled to the input fiber, for receiving light from the input fiber;
a mirror, coupled to the lens, for reflecting the light after the light is transmitted through the lens;
an output fiber, coupled to the lens, for receiving the light transmitted with a predetermined amount of mode-field-diameter dispersion after the light is reflected from the mirror and retransmitted through the lens for wavelength-dependent-loss reduction.

12. The system as claimed in claim 11 wherein the output fiber is for receiving the light having a first output mode with a size matched a size of a first fiber mode, the first output mode corresponding to the light from the lens.

13. The system as claimed in claim 11 wherein the output fiber is for receiving the light having a first output mode concentric with a second output mode, the first output mode corresponding to the light from the lens.

14. The system as claimed in claim 11 further comprising:
a power supply, coupled to the mirror, for supplying a voltage; and wherein:
the mirror is rotated with the voltage supplied.

15. The system as claimed in claim 11 wherein the mirror includes a reflective element integral with rotor electrode comb fingers, the light from the lens reflected with the rotor electrode comb fingers rotated.

16. The system as claimed in claim 11 wherein the mirror provides a reflective offset for reflecting the light partially offset when the light is transmitted to the output fiber.

17. The system as claimed in claim 16 wherein the output fiber is for receiving the light having a first output mode with a size matched a size of a first fiber mode, the first output mode corresponding to the light from the lens and partially overlapped with the first fiber mode.

18. The system as claimed in claim 16 wherein the output fiber is for receiving the light having a first output mode and a second output mode that are concentric, a wavelength corresponding to the first output mode longer than a wavelength corresponding to the second output mode with the first output mode corresponding to the light from the lens.

19. The system as claimed in claim 16 further comprising:
a power supply, coupled to the mirror, for supplying a voltage; and wherein:
the mirror includes rotor electrode comb fingers rotated with the voltage supplied.

20. The system as claimed in claim 16 wherein the mirror includes a rotation hinge and a reflective element integral with rotor electrode comb fingers, the light from the lens reflected with the rotor electrode comb fingers rotated and parallel to the rotation hinge.

21. The method as claimed in claim 1 wherein coupling the input fiber and positioning the output fiber includes the input fiber, the output fiber, or a combination thereof is a reduced-bend-radius fiber.

22. The system as claimed in claim 11 wherein the input fiber, the output fiber, or a combination thereof is a reduced-bend-radius fiber.
